(19) United States
(12) Patent Application Publication
(10) Pub. No.: US 2005/0123664 A1
(43) Pub. Date: Jun. 9, 2005

(54) Method of cutting meat to form a simulated tenderloin meat product and meat product made using the method

(75) Inventor: Eugene D. Gagliardi JR., Atglen, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Packerland Packing Company, Inc.

(21) Appl. No.: 10/985,211

(22) Filed: Nov. 10, 2004

Related U.S. Application Data
(60) Provisional application No. 60/527,080, filed on Dec. 4, 2003.

(51) Int. Cl. A23B 4/00

(52) U.S. Cl. 426/518

(57) ABSTRACT

A method of cutting a primal cut of meat having a width, a thickness and an elongated length with the grain of the meat extending generally parallel to the length to form a meat product simulating the appearance of a tenderloin comprises cutting the primal cut along a first cut line. The first cut line extends through the thickness and along the length of the primal cut to separate a first meat portion from the remainder of the primal cut. The first cut line is spaced from a lateral side of the primal cut by a predetermined distance generally corresponding to the thickness of the primal cut so that the first meat portion is elongated and generally square shaped in end view. The first meat portion is then cut along four generally curved second cut lines along the entire length of the first meat portion for removing the four corner pieces of the first meat portion when seen in end view. The removal of the four corner pieces results in the first meat portion being generally cylindrically shaped and having an appearance simulative of a tenderloin.

### CROSS-REFERENCE TO RELATED APPLICATIONS

This Patent Application claims the priority of U.S. Provisional Patent Application No. 60/527,080 filed Dec. 4, 2003 and entitled “Method of Cutting Meat to Form a Simulated Tenderloin Cut and Meat Cut Using the Method”, the entire subject matter of which is hereby incorporated herein by reference.

### BACKGROUND OF THE INVENTION

The present invention relates to meat cutting and, more particularly, to a method of cutting a piece of meat in a manner such that the resulting meat product simulates at least the appearance of a tenderloin cut.

Tenderloins, such as beef tenderloins, pork tenderloins, etc. have become increasingly popular meat products. There are a variety of reasons for such popularity including the fact that such tenderloin cuts or products are boneless, relatively low in fat and are conveniently packaged for relatively easy preparation and consumption with little or no waste. Another feature of such tenderloin products is the fact that the tenderloin products are generally elongated and generally cylindrical with the grain of the meat extending generally along the length of the cylinder. In this manner, after cooking, portions of the cylindrically shaped tenderloin product can be naturally sliced off by cutting across the length of the cylinder, generally perpendicular to the cylindrical axis for consumption with the advantage that all of the slices will be across the grain.

The present invention comprises a method of cutting a portion of meat, particularly a primal cut of meat, in such a manner that the resulting meat product simulates the appearance as well as other characteristics of a tenderloin. A meat product prepared in accordance with the method of the present invention is generally elongated and generally cylindrical with the grain of the meat extending along the length of the cylinder and generally parallel to the cylindrical axis. In this manner, a meat product prepared in accordance with the method of the present invention can be conveniently cut or sliced across the length, generally perpendicular to the axis of the cylinder such that all of the slices are across the grain of the meat.

### BRIEF SUMMARY OF THE INVENTION

Briefly stated, the present invention comprises a method of cutting a primal cut of meat having a width, a thickness and an elongated length with the grain of the meat extending generally parallel to the length to form a meat product simulating the appearance of a tenderloin. The method involves cutting the primal cut along a first cut line extending through the thickness and along the length of the primal cut to separate a first meat portion from the remainder of the primal cut. The first cut line is spaced from a lateral side of the primal cut by a predetermined distance generally corresponding to the thickness of the primal cut so that the first meat portion is elongated and generally square shaped in end view. The first meat portion is then cut along four generally curved second cut lines along the entire length of the first meat portion for removing the four corner pieces of the first meat portion when seen in end view. The removal of the four corner pieces results in the first meat portion being generally cylindrically shaped and having an appearance simulative of a tenderloin.

### BRIEF DESCRIPTION OF THE SEVERAL VIEWS OF THE DRAWINGS

The foregoing summary as well as the following detailed description of a preferred embodiment of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a top perspective view of a top round of beef which will be used for illustrating the preferred embodiment of the method of the present invention;

FIG. 2 is a top perspective view of the top round of beef as shown in FIG. 1 annotated with a plurality of first cut lines in accordance with the preferred embodiment of the method of the present invention;

FIG. 3 is an end view of a first portion of the top round shown in FIG. 1 annotated with second generally curved cut lines in accordance with the preferred embodiment of the method of the present invention; and

FIG. 4 is a perspective view of a beef product which has been made from the top round of FIG. 1 in accordance with the preferred embodiment of the method of the present invention.

### DETAILED DESCRIPTION OF THE INVENTION

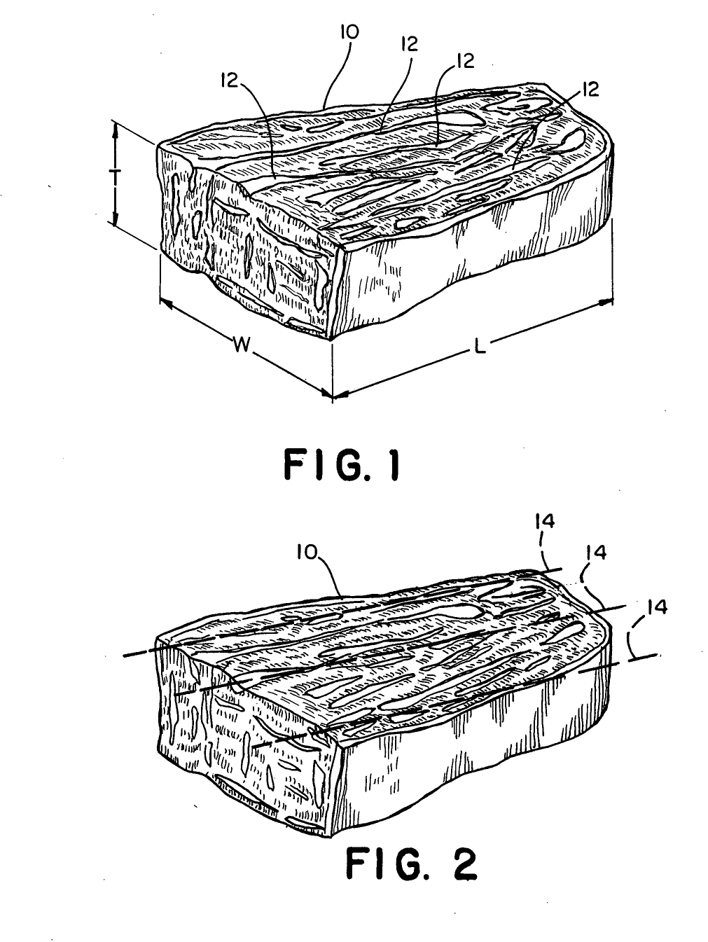

The present invention comprises a method of cutting various types of meat in a manner so that the resulting cut or meat product simulates, at least the appearance of a tenderloin product of the type well known to those of ordinary skill in the art. More particularly, and as illustrated in FIG. 4, the meat cut or meat product which results from employing the method of the present invention is an elongated generally cylindrical piece of meat with no bone, little or no fat or other waste and with the grain of the meat extending generally along the length (parallel to the axis) of the cylindrical meat cut. In this manner, the meat product may be conveniently sliced across the grain (generally perpendicular to the axis) to provide generally round or oblong meat slices which simulate the slices made from a traditional tenderloin. It should be appreciated by those of ordinary skill in the art that while the method of the present invention is illustrated in FIGS. 1-4 utilizing a top round of beef, the meat cutting method in accordance with the present invention is not limited to beef but is equally applicable to other types of meat including, but not limited to, pork, veal, or any other consumable meat.

FIG. 1 is a perspective view of a typical top round of beef 10 which is utilized only for illustrating the method of the present invention. Although a top round of beef 10 is illustrated in FIG. 1, the method of the present invention is equally applicable to any other primal cut of beef such as a bottom round of beef, or, as mentioned above, a primal muscle of any other animal such as a top or bottom round of pork, veal, etc. As shown in FIG. 1, in the top round of beef 10 the grain of the meat, as illustrated by grain lines 12, extends generally along the elongated length L. The top round 10 has a width W and a thickness T as shown.

FIG. 2 shows the beef round 10 of FIG. 1 with the addition of several first cut lines 14. The first cut lines 14 extend along the elongated length of the beef round 10 essentially with or parallel to the grain of the meat as illustrated by grain lines 12 and through the thickness T of the beef round 10. The cut lines 14 are also generally parallel to each other and are spaced from a lateral side of the beef round 10 and from each other along the width W by a predetermined distance which generally corresponds to the thickness T of the beef top round 10. Thus, for example, in a beef top round 10 having a typical thickness T of about three inches, the spacing form the lateral side and between the generally parallel first cut lines 14 is approximately three inches. Of course, the number of cut lines 14 and the spacing of the cut lines 14 will vary depending upon the width W of the top round 10 or other piece of meat being cut.

The first step of the present method comprises cutting the top round 10 along each of the first cut lines 14 and through the thickness to separate the top round 10 into two or more individual pieces or first portions of top round 10a. The cuts through the top round 10 may be made utilizing a standard butcher knife (not shown) or any other cutting device or apparatus well known to those of ordinary skill in the art. For example, the top round 10 may be cut utilizing a standard meat saw, water knife or the like. It will be appreciated by those of ordinary skill in the art that the present invention is not limited to the particular knife or other apparatus used for making the cuts through the top round 10.

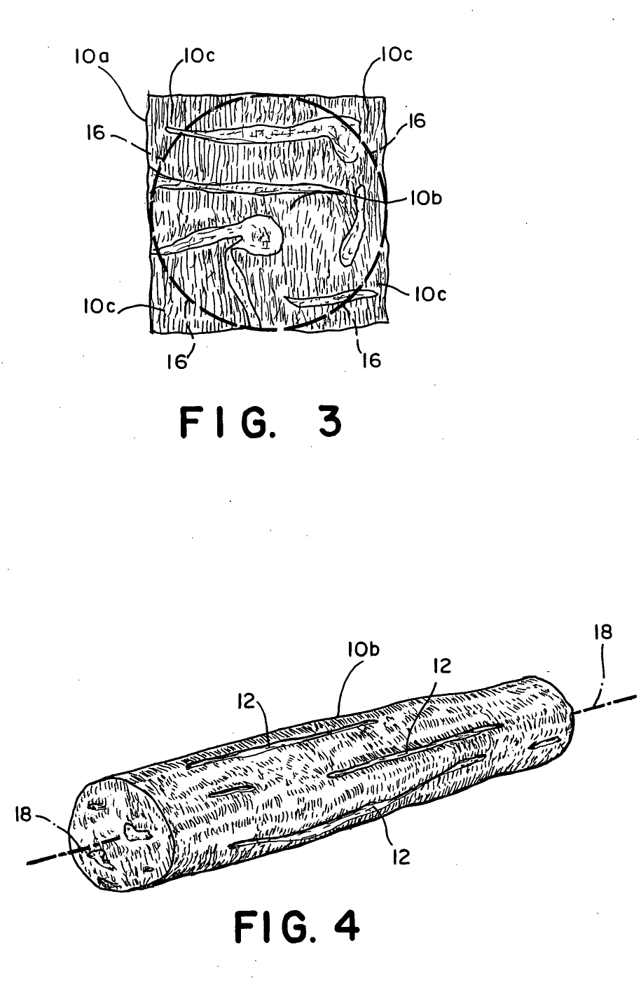

Cutting the top round 10 along each of the first cut lines 14 results in a plurality of individual top round pieces or first top round portions, one of which is illustrated as 10a on FIG. 3. Each of the first top round portions 10a is generally elongated with a length L and is generally square shaped in end view with the width and thickness being equal. When starting with a typical top round 10 with a typical thickness T of about three inches, the sides (thickness and width) of the top round portions 10a when viewed from the end are each about three inches. The following description relates to the further processing of a single first top round portion 10a. It should be understood by those of ordinary skill in the art that the same processes and techniques may also be used in connection with the remaining pieces or portions 10a of the top round 10.

Referring to FIG. 3, the top round portion 10a is shown with four second cut lines 16. The second cut lines 16 are generally curved and extend proximate to each of the four corners of the first top round portion 10a when seen in end view. The next step involved in the present invention is to cut the first top round portion 10a along each of the four second cut lines 16 for its entire axial or elongated length. Making the cuts along the generally curved cut lines 16 results in the removal of each of the four corner pieces 10c of the first top round portion 10a thereby creating a first top round portion 10b which is generally round or oblong in cross section or end view and, as shown in FIG. 4, is generally cylindrically shaped. The removed corner pieces 10c of the first top round portion 10a can be used for ground beef or can be otherwise made into any other suitable beef product. The cylindrical appearance of the resulting first top round portion 10b is similar to that of pork or other tenderloin. In addition, as previously discussed, the grain of the first top round portion 10b extends generally along the length of the cylinder, generally parallel to the cylindrical axis 18 as illustrated by grain lines 12. It is generally well known that tenderloin or any other cylindrical piece of meat, once cooked, naturally tends to be sliced generally perpendicular to the axis 18. Thus, when the first top round portion 10b is sliced generally perpendicular to the axis 18 the generally circular meat slices will be generally across the grain of the top round portion 10b.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of cutting a primal cut of meat having a width, a thickness and an elongated length, the grain of the meat extending generally parallel to the length, to form a meat product simulating the appearance of a tenderloin comprising the steps of:
cutting the primal cut along a first cut line extending through the thickness, along the length and generally parallel to the grain of the meat to separate a first meat portion from the remainder of the primal cut, the first cut line being spaced from a lateral side of the primal cut along the width of the primal cut by a predetermined distance generally corresponding to the thickness of the primal cut so that the first meat portion is elongated and generally square shaped in end view; and
cutting the first meat portion along four generally curved second cut lines extending along the entire length of the first meat portion for removing the four corner pieces of the first meat portion when seen in end view, the removal of the four corner pieces resulting in a generally cylindrically shaped first meat portion having an appearance simulative of a tenderloin.

2. The method as recited in claim 1, further comprising the steps of:
cutting the remainder of the primal cut along additional generally parallel first cut lines extending through the thickness and spaced from each other by the predetermined distance to provide additional generally elongated meat portions which are generally square shaped in end view; and
cutting each of the additional meat portions along four generally curved second cut lines along their entire lengths for removing the four corner pieces of each meat portion when seen in end view, the removal of the four corner pieces resulting in each of the additional meat portions being generally cylindrically shaped and each having the appearance of a tenderloin.

3. The method as recited in claim 1 wherein the primal cut is a beef round.

4. A meat product made in accordance with the method of claim 1.

5. A beef tenderloin product made in accordance with the method of claim 1 using a round of beef as the primal cut.
